(19) United States
(12) Patent Application Publication
(10) Pub. No.: US 2005/0256013 A1
(43) Pub. Date: Nov. 17, 2005

(54) Bar-oil growth retardant

(76) Inventor: Kelly Jean Davies, Carmichael, CA (US)

Correspondence Address: RISTO A. RINNE, JR.;COMPLETE PATENTING SERVICES, 2173 EAST FRANCISCO BOULEVARD, SUITE E, SAN RAFAEL, CA, 94901, US

(21) Appl. No.: 10/845,344

(22) Filed: May 12, 2004

(51) Int. Cl. C10M 101/00; A01N 55/02

(52) U.S. Cl. 508/525; 508/526

(57) ABSTRACT

An apparatus and method for applying a growth retardant automatically to a cut end of a branch or limb, including adding a quantity of the growth retardant to a lubricant of the type that is used to lubricate a chain of a chain saw. A resultant product is provided that is applied to a reservoir of a chain saw which is adapted to receive the lubricant. The flow rate of the lubricant to the chain is adjusted, and the branch is severed by the chain saw thereby producing the cut end. A quantity of the growth retardant and lubricant are applied automatically to the cut end as the branch is severed. The lubricant maintains the growth retardant in contact with the cut end for a sufficient period of time to achieve a desired level of efficacy at retarding the formation and new growth of shoots from the cut end.

### BACKGROUND OF THE INVENTION

1. Field of the Invention

The present invention, in general, relates to chain saws and, more particularly, to an additive for the oil that lubricates the bar of a chain saw.

Chain saws are well known devices for sawing wood. They include a bar and a chain that orbits the bar. The chain includes gear teeth that are disposed in a rail in the bar and are driven by a drive gear. The engine or motor turns the drive gear. The side of the chain opposite the gear teeth includes saw teeth that are adapted for cutting wood.

Virtually all chain saws include a lubricant for the chain as it rotates around the bar. These types of lubricants are referred to in general as a “bar-oil”. Most chain saws automatically dispense the bar-oil as the chain rotates. A pump is driven by the drive gear or otherwise that constantly delivers a small quantity of bar-oil to the bar through a small port (i.e., hole) in the bar and eventually to the chain.

The bar-oil reduces friction of the chain which makes it run quieter and cooler. The bar-oil extends the useful life of both the bar and the chain. Certain types of bars include a sprocket at the end (i.e., nose) of the bar that engages with the gear teeth of the chain and which elevates the chain slightly above the nose of the bar, thereby reducing friction as the chain reverses its direction of travel. The bar-oil also helps to lubricate the sprocket to some degree.

However, the bar-oil does not remain on the chain for an extended period of time. As the chain cuts through the wood (i.e., trees, branches, limbs, etc.), the wood scuffs a certain amount of the bar-oil off the chain, thereby necessitating a need to continually replace the bar-oil during use. Also, centrifugal force of the chain expels a certain amount of bar-oil off the chain as well.

Because the viscosity and other characteristics of various bar-oils vary, it is often necessary to vary the rate of flow of the bar-oil. Most higher-quality types of chain saws allow the operator to vary and adjust the rate of flow of the bar-oil that is being delivered to the bar and chain.

Up until now, the main considerations for chain saw bar-oil included an analysis of how well it lubricated the bar and chain and also how well it adhered to both.

A common use for a chain saw is to prune trees. Pruning (i.e., also known as “trimming”) is the cutting off of branches and limbs, even an entire severing of the tree at its trunk in some cases. Pruning is done for a variety of reasons. In general, these reasons all include a need to reduce the above-ground mass of the tree for one reason or another.

Perhaps a tree has overgrown into a road or driveway. Perhaps a tree has had its limbs grow too close to a building or into a path or walkway. Perhaps the limbs are encroaching on cable, telephone, power, or other utility lines. Perhaps a tree has grown in an imbalanced manner that is deemed to be unsightly. Perhaps a tree must occupy a limited amount of space (i.e., volume) so as not to encroach on a neighbor's property so that any growth is seen as undesirable. Perhaps it is desirable to prevent a tree from expanding outward and is desirable to, instead, fill portions of a tree in with new growth but within a smaller overall volume. The pruning of fruit trees is one such example. In any event, it is periodically necessary to trim off a certain amount of many trees.

If a tree, shrub, or bush is trimmed, it is reasonable to assume that in virtually all such cases it is desirable that it not grow back again in the manner that it had, or at least that it not do so too quickly, lest additional expense be required to again trim (i.e., prune) the tree, shrub, or bush. Many people do not prune their own trees or shrubs but contract out for such service at considerable expense. Those who do it themselves soon realize that it is an especially difficult and time-consuming work.

However, many trees, shrubs, and bushes quickly grow back from the exact location that they were previously pruned (i.e., cut). It is not uncommon for certain arborists to return every year to prune the same trees, shrubs, and bushes because they have again grown back the same tree mass in the same places.

The only known way to retard such growth is by the use of a growth retardant that is applied to the cutting (i.e., to the remaining limb where it has been severed), and then the growth retardant is covered with asphalt. The use of a growth retardant, and many such products are commercially available, will typically suppress the growth or new shoots by about 50%. Those shoots that do grow back will typically do so at about 50% the rate that they would have without addition of the growth retardant.

Accordingly, the use of the growth retardant, when properly applied as is described in greater detail below, extends the time required between cutting (pruning/trimming) procedures.

One type of growth retardant for trees is known as “naphtheleneacidic acid”, and it is commercially available.

However, there are problems associated with the use of growth retardants and an asphalt covering. The first is simply that it takes a lot of time to go back and apply the growth retardant to each limb where it has been severed.

This problem is more acute than it might, at first consideration, appear. When limbs are severed by use of the chain saw, the operator of the chain saw does not have to physically reach the limb with his or her hands. The chain saw and its bar extend the operator's reach from a little over a foot (with a small chain saw) to over a yard (with a large chain saw).

However, when the operator goes back to apply the growth retardant to the cutting, the operator must now actually reach the portion of the limb where it was cut in order to apply, by hand, the growth retardant. This may necessitate the operator climbing higher into the tree that is more difficult and time-consuming at best, precarious and dangerous at worst.

Even when limbs are easy to reach, it still takes time to first apply the growth retardant and then the asphalt. The asphalt holds the growth retardant against the cut portion of the limb, where it is absorbed and, therefore, effective. It is not desirable to simply apply the growth retardant to the cutting and hope for the best as rain and wind are likely to remove it off the cutting.

Another problem with this approach is that the asphalt tends to trap moisture between itself and the cutting. Rain can enter from the top or through cracks and be retained therein. Changes in temperature from one side of the asphalt to the other can cause water vapor to precipitate and condense on the inside of the asphalt.

The moisture that is trapped between the asphalt and the cut portion of the tree limb will rot or decay the tree over time. The tree is weakened and is more susceptible to disease or insect infestation. Accordingly, the life expectancy, and even the very survival of the tree, can be put at risk.

Accordingly, there exists today a need for a product and method that helps retard the growth of shoots from cuttings and which helps ameliorate the above-mentioned problems inherent with the known products and methods.

Clearly, such a product and method would be useful and desirable.

2. Description of Prior Art

Bar-oils for use in lubricating a chain and bar of a chain saw are, in general, known. While the structural arrangements of the above described products may, at first appearance, have similarities with the present invention, they differ in material respects. These differences, which will be described in more detail hereinafter, are essential for the effective use of the invention and which admit of the advantages that are not available with the prior methods or products.

### OBJECTS AND SUMMARY OF THE INVENTION

It is an object of the present invention to provide a bar-oil growth retardant that helps prevent the growth of shoots after cutting.

It is also an important object of the invention to provide a bar-oil growth retardant that helps reduce the rate of growth of shoots after cutting.

Another object of the invention is to provide a bar-oil growth retardant that provides a way to apply a growth retardant quickly to a limb that is to be cut.

Still another object of the invention is to provide a bar-oil growth retardant that provides a way to apply a growth retardant easily to a limb that is to be cut.

Still yet another object of the invention is to provide a bar-oil growth retardant that prevents the step of having to go back and apply a growth retardant to a cut limb.

Yet another important object of the invention is to provide a bar-oil growth retardant that prevents the step of having to go back and apply asphalt over a growth retardant that has been applied to a cut limb.

Another important object of the invention is to provide a bar-oil growth retardant that eliminates the need to apply asphalt over a cut limb.

A first continuing object of the invention is to provide a bar-oil growth retardant that eliminates the need to apply asphalt over a cut limb that has had a growth retardant applied thereto.

A second continuing object of the invention is to provide a bar-oil growth retardant that prevents water damage to a tree from water that is trapped between asphalt and a cut limb.

Briefly, a bar-oil growth retardant that is constructed in accordance with the principles of the present invention includes a bar-oil lubricant for use in lubrication the bar and chain of a chain saw. A growth retardant is mixed in with the bar-oil. The mixture is then added to a reservoir of a chain saw that holds the bar-oil and is delivered to the limb automatically while the limb is being severed. The mixture, as it is applied to the cutting, forms a film that retains the growth retardant proximate the end of the limb that has been cut for a sufficient amount of time to yield effective results. Two steps of manually applying the growth retardant and then of applying a coating or seal, such as asphalt, over the end of the limb that has been cut are eliminated. The rate of flow of the bar-oil is adjusted, as desired, to deliver the mixture at a preferred flow rate.

### BRIEF DESCRIPTION OF THE DRAWINGS

FIG. 1 is a block diagrammatic view of a bar-oil growth retardant.

FIG. 2 is a view in perspective of the bar-oil growth retardant of FIG. 1 being applied as a limb is cut.

### DETAILED DESCRIPTION OF THE INVENTION

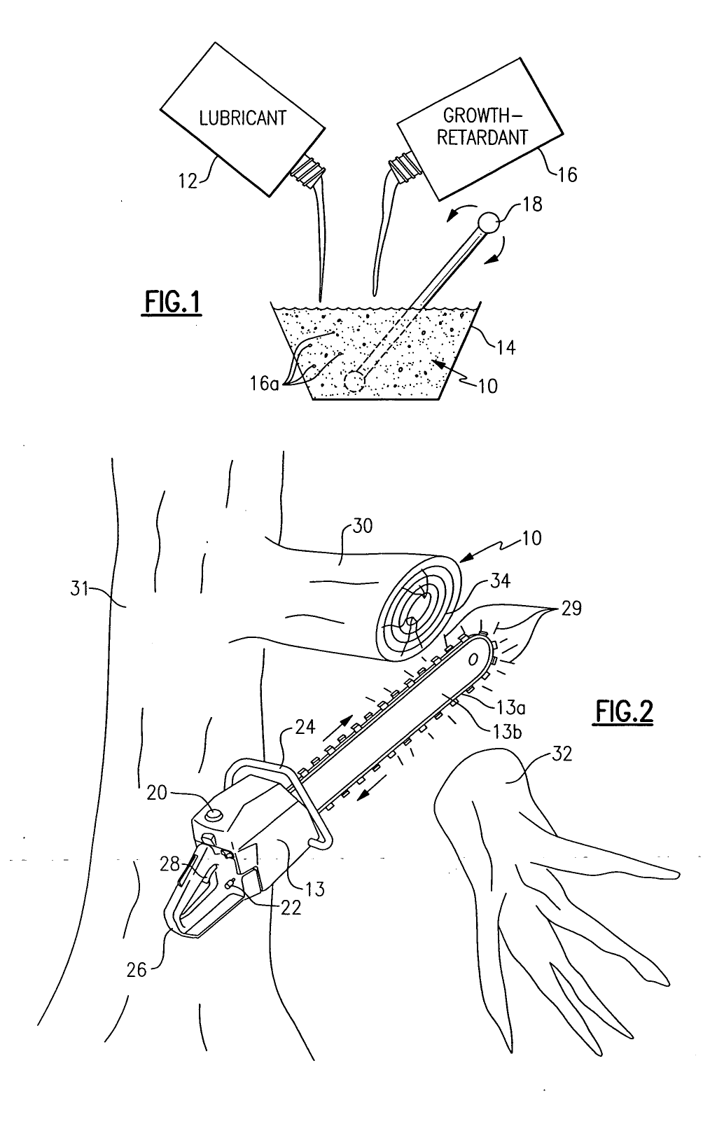

Referring to FIG. 1, and also on occasion to FIG. 2, a bar-oil growth retardant is shown, identified, in general, by the reference numeral “10”.

A quantity of a lubricant 12 is added to a container 14. The lubricant 12 can include any type of fluid that can possibly be used to reduce friction of a chain 13a as it passes over a bar 13b of a chain saw 13. While most types of the lubricant 12 are petroleum-based, the lubricant 12 can include, for example, any type of natural oil, such as olive oil, canola oil, peanut oil, safflower oil, corn oil, etc., as may be desired.

A quantity of the growth retardant 16 is also added to the container 14. The growth retardant 16 and the lubricant 12 are mixed together, as indicated by movement of a stirring rod 18.

A preferred type of the growth retardant 16 includes naphtheleneacidic acid.

After mixing (i.e., stirring), the growth retardant 16 molecules 16a are dispersed throughout the lubricant 12. The resultant combination provides the bar-oil growth retardant 10.

Depending upon the type of the lubricant 12 and the type of the growth retardant 16 and also possibly whether or not other materials are added as well, the bar-oil growth retardant 10 can be in the form of a mixture or a solution.

The ratio of the lubricant 12 to the growth retardant 16 is a variable that depends upon several factors including the type of material used for the lubricant 12, the material used for the growth retardant 16, the desired efficacy, the rate of application (as is described in greater detail hereinafter), the weather (if it is dry and sunny or raining when used), and other factors.

The bar-oil growth retardant 10 is then either used or repackaged for resale.

When the bar-oil growth retardant 10 is to be used, it is poured into a bar-oil compartment 20 of the chain saw 13. The rate of flow of the bar-oil growth retardant 10 to the chain 13a is varied by adjusting a flow control knob 22 of the chain saw 13.

The chain saw 13 motor is started, an upper handle 24 and rear handle 26 are grasped and the rate of fuel flow to the motor is increased by pressing a throttle trigger 28 that, in turn, increases motor speed thereby causing the chain 13a to rotate around the bar 13b, as shown, at high speed. This also causes the bar-oil growth retardant 10 to be supplied to the chain 13a in sufficient quantity. A portion of the bar-oil growth retardant 10 is released from contact with the chain 13a by centrifugal force in the form of a mist 29.

The bottom of the bar 13b is then placed atop the branch 30 to be cut. The branch 30 is part of a tree, shrub, or bush 31. The chain 13a cuts the branch 30 as the bar 13b descends downward until the limb 32 (i.e., a portion of the branch 30) has been severed and falls to the ground.

As shown, the bar 13b has just passed through the branch 30 from top to bottom. The end of the branch 30 that has been severed includes the cut end 34. A plurality of growth rings (reference number omitted), as is well-known in the tree cutting arts, is seen at the cut end 34.

A quantity of the bar-oil growth retardant 10 is applied to the cut end 34 by either or both of two primary mechanisms. The first mechanism of application is by contact of the chain 13a that contains the bar-oil growth retardant 10 with the cut end 34 as it passes through the branch 30. The second method of application is that the mist 29 continually sprays a fine coating over the cut end 34 after the bar 13b and the chain 13a have passed by.

When the flow rate of the bar-oil growth retardant 10 has been properly adjusted, a sufficient quantity of the bar-oil growth retardant 10 has been applied to the cut end 34.

The molecules 16a of the growth retardant 16 are held in contact with the cut end 34, partly because of the adhesive characteristics of the lubricant 12 and partly because of the adhesive characteristics of the growth retardant 16 as well. The bar-oil growth retardant 10 ensures that the growth retardant 16 will affect the cut end 34 sufficient to either prevent or retard the formation of new growth (not shown) from the cut end 34, and if new growth should occur, the growth retardant will retard its rate of growth.

The lubricant 12 eventually dissipates from the cut end 34. Accordingly, unlike the prior art that used a coating of asphalt (not shown) which was applied over the cut end 34, no moisture is trapped and held against the cut end 34. There is no increased tendency due to the trapping of moisture that can occur when using the bar-oil growth retardant 10 that might cause the cut end 34 to rot or assimilate the growth of disease or an infestation by insects. Accordingly, the tree, shrub, or bush 31 experiences better health.

It is noted that the growth retardant 16 is applied in an automatic way the moment the limb 32 is severed (i.e., cut). An operator (not shown) does not have to return to the cut end 34 to apply the growth retardant 16 and again to apply the asphalt. The growth retardant 16 is applied during the essential act of cutting the branch 30, which is required in order to remove the unwanted limb 32. The use of the asphalt is eliminated, thereby further reducing labor by eliminating the need to go back and to apply the asphalt to each cut end 34. Costs are also reduced by eliminating an additional material—the asphalt itself.

It is noted that the bar 13b and the chain 13a effectively extend the reach of the operator. With prior art methods, the operator had to reach the cut end 34 sufficient enough to make hand contact with it in order to apply the growth retardant 16 and then the asphalt over the growth retardant 16 to maintain it in position.

Accordingly, time is further saved by not requiring the operator to reach each and every cut end 34 after cutting. Forcing the operator to extend that additional amount may also place the operator in an awkward and possibly precarious position from which the operator might fall. Thus, use of the bar-oil growth retardant 10 also promotes the safety of the operator.

The invention has been shown, described, and illustrated in substantial detail with reference to the presently preferred embodiment. It will be understood by those skilled in this art that other and further changes and modifications may be made without departing from the spirit and scope of the invention which is defined by the claims appended hereto.

1. An improved lubricant of the type that is used to lubricate a bar of a chain saw, wherein the improvement comprises: adding a quantity of a growth retardant to said lubricant.

2. The improved lubricant of claim 1 wherein said growth retardant includes naphtheleneacidic acid.

3. An improved lubricant of the type that is used to lubricate a chain of a chain saw, wherein the improvement comprises: adding a quantity of a growth retardant to said lubricant.

4. The improved lubricant of claim 3 wherein said growth retardant includes naphtheleneacidic acid.

5. A method for applying a growth retardant to a cut end of a branch that is severed by a chain saw, comprising the steps of:
(a) adding a quantity of a growth retardant to a lubricant that is used to reduce friction of a chain against a bar of said chain saw;
(b) adding said quantity of said growth retardant and said lubricant to a reservoir in said chain saw wherein said reservoir is adapted to receive said lubricant; and
(c) cutting said branch with said chain saw sufficient to produce said cut end.

6. The method of claim 5 including the additional step of stirring said growth retardant and said lubricant after the step of adding said quantity of said growth retardant to said lubricant and prior to the step of adding said quantity of growth retardant and said lubricant to said reservoir.

7. The method of claim 5 including the additional step of adjusting the rate of delivery of said quantity of growth retardant and said lubricant by said chain saw to said chain prior to the step of cutting said branch.
